(19) United States
(12) Patent Application Publication
(10) Pub. No.: US 2026/0210792 A1
(43) Pub. Date: Jul. 23, 2026

(54) APPARATUS FOR DETERMINING LEAKAGE USING PIPELINE CHARACTERISTICS AND NOISE PATTERN, AND LEARNING METHOD THEREOF

(71) Applicant: SC SOLUTION GLOBAL CO., LTD, Daegu (KR)

(72) Inventor: Kwang Yun NA, Yongin-si (KR)

(73) Assignee: SC SOLUTION GLOBAL CO., LTD, Daegu (KR)

(21) Appl. No.: 19/569,235

(22) Filed: Mar. 17, 2026

Related U.S. Application Data
(63) Continuation of application No. PCT/KR2024/013664, filed on Sep. 10, 2024.

(30) Foreign Application Priority Data
Sep. 19, 2023 (KR) 10-2023-0124654

(51) Int. Cl. G01M 3/24; G01M 3/00; G01N 29/32; G01N 29/44

(52) U.S. Cl. CPC G01M 3/243; G01M 3/007; G01N 29/32; G01N 29/4481

(57) ABSTRACT

An apparatus for determining leakage using pipeline characteristics and a noise pattern according to the present disclosure comprises: a memory in which at least one process for determining leakage using pipeline characteristics and a noise pattern is stored; and a processor for performing an operation according to the process,

### CROSS-REFERENCE TO RELATED APPLICATIONS

The present application is a continuation of International Patent Application No. PCT/KR 2024/013664, filed on Sep. 10, 2024, which is based upon and claims the benefit of priority to Korean Patent Application No. 10-2023-0124654 filed on Sep. 19, 2023. The disclosures of the above-listed applications are hereby incorporated by reference herein in their entirety.

### BACKGROUND

Embodiments of the present disclosure described herein relate to an a leakage determination apparatus and a learning method thereof, and more particularly, relate to a leakage determination apparatus using pipeline characteristics and a noise pattern that classifies signals collected according to pipeline characteristics and performs leakage determination by removing corresponding noise pattern signals from the classified signals.

Inside pipelines such as water supply pipes, repeated use may cause sedimentation, accumulation, and suspension, and may lead to the buildup of foreign matter and subsequent corrosion. Moreover, cracks may occur due to external environmental influences, thereby potentially causing leakages in pipelines.

In particular, water supply pipes used in various buildings such as apartments, single-family homes, and buildings are composed of pipes made from diverse materials, including polybutylene pipes, metal corrugated pipes, copper pipes, stainless steel pipes, polyethylene pipes, and cross-linked polyethylene pipes.

When a leakage occurs in the water supply pipes, the location of the leakage needs to be found by using a leakage detection apparatus. However, the characteristics of water supply pipes vary depending on the material, and thus the accuracy of leakage detection location may differ for each material when a single leakage detection apparatus is used.

Conventionally, nitrogen detectors were used to detect whether nitrogen is leaked to detect a leakage location regardless of the pipeline material. However, detecting the location of leaking nitrogen alone makes it physically difficult to detect the exact location of a leakage within a pipeline.

Furthermore, even when learning is performed by using an AI model so as to detect a leakage detection location, maintaining high prediction accuracy is difficult because learning data varies depending on a water pipe material.

In addition, when a vibration signal is collected to detect leak locations, surrounding noise and the sound of water used by consumers using a water pipeline are captured in the vibration signal, thereby reducing the accuracy of leakage location detection.

### SUMMARY

Embodiments of the present disclosure provide a leakage determination apparatus using pipeline characteristics and a noise pattern that detects the exact leakage location by classifying vibration signals depending on the material properties and noise type of a pipeline, and a learning method thereof.

Problems to be solved by the present disclosure are not limited to the problems mentioned above, and other problems not mentioned will be apparent by those skilled in the art from the following description.

According to an embodiment, an apparatus for determining a leakage using pipeline characteristics and a noise pattern includes a memory, in which at least one process for determining the leakage using the pipeline characteristics and the noise pattern is stored, and a processor that performs an operation according to the process. The processor is configured to preset a pattern of a leakage signal generated in the pipeline, to collect a vibration signal from a sensor unit installed in the pipeline, to remove a signal according to the pipeline characteristics from a collected vibration signal, to compare a removed vibration signal with a preset noise pattern so as to remove a corresponding noise pattern, and to generate a vibration signal, from which the noise pattern is removed, as learning data so as to determine whether a leakage occurs, through a comparison with the set pattern of the leakage signal.

According to an embodiment, a method, which is performed by a processor of an apparatus and which is used to generate learning data for leakage determination using pipeline characteristics and a noise patterns includes presetting a pattern of a leakage signal generated in a pipeline, collecting a vibration signal from a sensor unit installed in the pipeline, removing a signal according to the pipeline characteristics from a collected vibration signal, comparing a removed vibration signal with a preset noise pattern so as to remove a corresponding noise pattern, and generating a vibration signal, from which the noise pattern is removed, as learning data so as to determine whether a leakage occurs, through a comparison with the set pattern of the leakage signal.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a block diagram schematically illustrating a configuration for detecting a leakage location in a leakage determination apparatus using pipeline characteristics and a noise pattern, according to various embodiments of the present disclosure;

FIG. 2 is a block diagram schematically illustrating a configuration for determining whether there is a leakage in a leakage determination apparatus using pipeline characteristics and a noise pattern, according to various embodiments of the present disclosure;

FIG. 3 is a conceptual diagram illustrating locations of a first sensor unit and a second sensor unit of a leakage determination apparatus using pipeline characteristics and a noise pattern, according to various embodiments of the present disclosure;

FIG. 4 illustrates a leakage signal and a leakage signal including noise collected by a leakage determination apparatus using pipeline characteristics and a noise pattern, according to various embodiments of the present disclosure;

FIG. 5 is a flowchart illustrating a learning method of a leakage determination apparatus using pipeline characteristics and a noise pattern, according to various embodiments of the present disclosure;

FIGS. 6 to 8 are graphs illustrating a noise signal pattern of a leakage determination apparatus using pipeline characteristics and a noise pattern, according to various embodiments of the present disclosure; and

FIG. 9 illustrates a computing device, according to an embodiment of the present disclosure.

### DETAILED DESCRIPTION

The same reference numerals denote the same elements throughout the present disclosure. The present disclosure does not describe all elements of embodiments. Well-known content in a technical field, to which the present disclosure belongs, or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, operating principles and embodiments of the present disclosure will be described with reference to the accompanying drawings.

In this specification, a ‘device according to an embodiment of the present disclosure’ includes all various devices capable of providing results to a user by performing arithmetic processing. For example, the device according to an embodiment of the present disclosure may include all of a computer, a server device, and a portable terminal, or may be in any one form.

Here, for example, the computer may include a notebook computer, a desktop computer, a laptop computer, a tablet PC, a slate PC, and the like, which are equipped with a web browser.

The server device may be a server that processes information by communicating with an external device and may include an application server, a computing server, a database server, a file server, a game server, a mail server, a proxy server, and a web server.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

Functions related to artificial intelligence according to an embodiment of the present disclosure are operated through a processor and a memory. The processor may consist of one or more processors. In this case, the one or more processors may be a general-purpose processor (e.g., a CPU, an AP, or a digital signal processor (DSP)), a graphics-dedicated processor (e.g., a GPU or a vision processing unit (VPU)), or an artificial intelligence (AI)-dedicated processor (e.g., an NPU). Under control of the one or more processors, input data may be processed depending on an AI model, or a predefined operating rule stored in the memory. Alternatively, when the one or more processors are AI-dedicated processors, the AI-dedicated processor may be designed with a hardware structure specialized for processing a specific AI model.

The predefined operating rule or the artificial intelligence model is created through learning. Here, being created through learning means creating the predefined operating rule or the artificial intelligence model configured to perform desired features (or purposes) as a basic artificial intelligence model is learned by using pieces of learning data by a learning algorithm. This learning may be performed by a device itself, on which the artificial intelligence according to an embodiment of the present disclosure is performed, or may be performed through a separate server and/or system. For example, the learning algorithm may include supervised learning, unsupervised learning, semi-supervised learning, or reinforcement learning, but may not be limited to the above example.

An artificial intelligence model may be composed of a plurality of neural network layers. The plurality of neural network layers respectively have a plurality of weight values, and each of the plurality of neural network layers performs neural network calculation through calculations between the calculation result of the previous layer and the plurality of weight values. The plurality of weight values of the plurality of neural network layers may be optimized by the learning result of the artificial intelligence model. For example, during a learning process, the plurality of weight values may be updated such that a loss value or a cost value obtained from the artificial intelligence model is reduced or minimized. The artificial neural network may include a deep neural network (DNN). The artificial neural network may be, for example, a convolutional neural network (CNN), a deep neural network (DNN), a recurrent neural network (RNN), a restricted Boltzmann machine (RBM), a deep belief network (DBN), a bidirectional recurrent deep neural network (BRDNN), or a deep Q-network, but is not limited to the above-described example.

According to an embodiment of the present disclosure, a processor may implement artificial intelligence. The artificial intelligence may refer to an artificial neural network-based machine learning method that allows a machine to perform training by simulating human biological neurons. The methodology of artificial intelligence may be classified as supervised learning, in which a solution (output data) to a problem (input data) is determined by providing input data and output data together as training data depending on a learning method, unsupervised learning, in which only input data is provided without output data, and thus the solution (output data) to the problem (input data) is not determined, and reinforcement learning, in which a reward is given from an external environment whenever an action is taken in a current state, and thus learning progresses to maximize this reward. Moreover, the methodology of artificial intelligence may also be categorized depending on architecture, which is the structure of the learning model. The architecture of deep learning technology widely used may be categorized into convolutional neural networks (CNN), recurrent neural networks (RNN), transformers, and generative adversarial networks (GAN).

Each of the present device and the system may include an artificial intelligence model. The artificial intelligence model may be a single artificial intelligence model or may be implemented as a plurality of artificial intelligence models. The artificial intelligence model may be composed of neural networks (or artificial neural networks) and may include a statistical learning algorithm that mimics biological neurons in machine learning and cognitive science. The neural network may refer to a model as a whole having the ability to solve problems as artificial neurons (nodes), which form a network by connecting synapses, changes the strength of their synaptic connections through learning. Neurons in the neural network may include the combination of weight values or biases. The neural network may include one or more layers consisting of one or more neurons or nodes. For example, the present device may include an input layer, a hidden layer, and an output layer. The neural network constituting the present device may infer the result (output) to be predicted from an arbitrary input by changing a weight value of a neuron through learning.

The processor may create a neural network, may train or learn a neural network, or may perform operations based on received input data, and then may generate an information signal or may retrain the neural network based on the performed results. Models of a neural network may include various types of models such as a convolutional neural network (CNN) (e.g., GoogleNet, AlexNet, or VGG Network), a region with convolutional neural network (R-CNN), a region proposal network (RPN), a recurrent neural network (RNN), a stacking-based deep neural network (S-DNN), a state-space dynamic neural network (S-SDNN), a deconvolutional network, a deep belief network (DBN), a restricted Boltzmann machine (RBM), a fully convolutional network, a long short-term memory (LSTM) Network, and a classification network, but is not limited thereto. The processor may include one or more processors for performing computations according to the models of the neural network. For example, the neural network may include a deep neural network.

It will be understood by those skilled in the art that a neural network may include any neural network, but is not limited to a convolutional neural network (CNN), a recurrent neural network (RNN), a perceptron, a multilayer perceptron, a feed forward (FF), a radial basis network (RBF), a deep feed forward (DFF), a long short term memory (LSTM), a gated recurrent unit (GRU), an auto encoder (AE), a variational auto encoder (VAE), a denoising auto encoder (DAE), a sparse auto encoder (SAE), a Markov chain (MC), a Hopfield network (HN), a Boltzmann machine (BM), a restricted Boltzmann machine (RBM), a deep belief network (DBN), a deep convolutional network (DCN), a deconvolutional network (DN), a deep convolutional inverse graphics network (DCIGN), a generative adversarial network (GAN), a liquid state machine (LSM), an extreme learning machine (ELM), an echo state network (ESN), a deep residual network (DRN), a differentiable neural computer (DNC), a neural turning machine (NTM), a capsule network (CN), a Kohonen network (KN), and an attention network (AN).

According to an embodiment of the present disclosure, the processor may use various artificial intelligence structures and algorithms such as a convolution neural network (CNN) (e.g., GoogleNet, AlexNet, or VGG Network), a region with convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzman machine (RBM), a fully convolutional network, a long short-term memory (LSTM) Network, a classification network, Generative Modeling, eXplainable AI, Continual AI, Representation Learning, AI for Material Design, algorithms for natural language processing (e.g., BERT, SP-BERT, MRC/QA, Text Analysis, Dialog System, GPT-3, and GPT-4), algorithms for vision processing (e.g., Visual Analytics, Visual Understanding, Video Synthesis, and ResNet), algorithms for data intelligence (e.g., Anomaly Detection, Prediction, Time-Series Forecasting, Optimization, Recommendation, and Data Creation), but is not limited thereto. Hereinafter, an embodiment of the present disclosure will be described in detail with reference to the accompanying drawings.

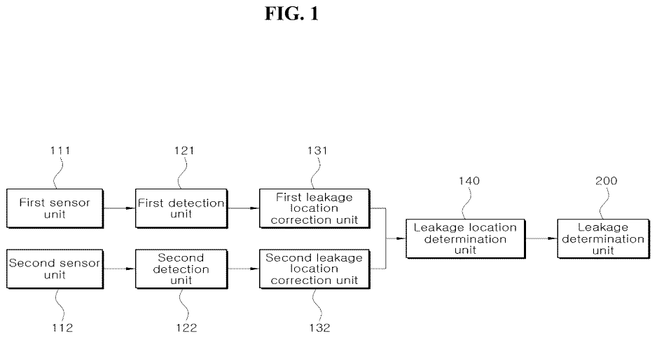

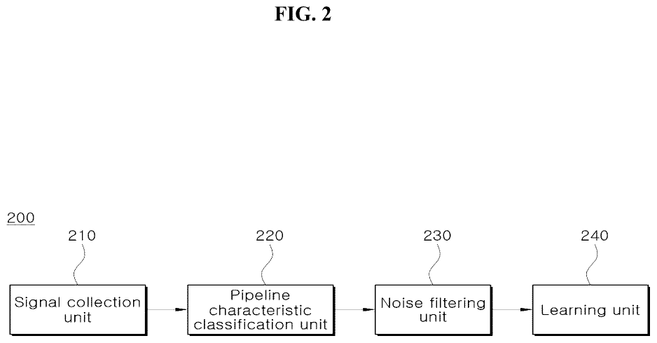

FIG. 1 is a block diagram schematically illustrating a configuration for detecting a leakage location in a leakage determination apparatus using pipeline characteristics and a noise pattern, according to various embodiments of the present disclosure. FIG. 2 is a block diagram schematically illustrating a configuration for determining whether there is a leakage in a leakage determination apparatus using pipeline characteristics and a noise pattern, according to various embodiments of the present disclosure.

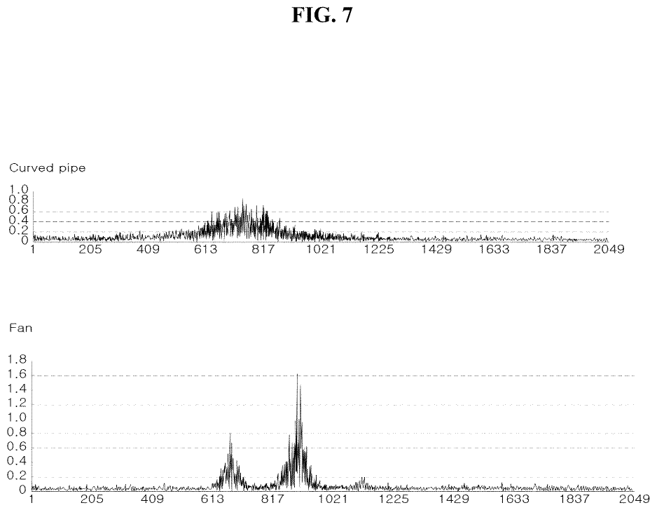

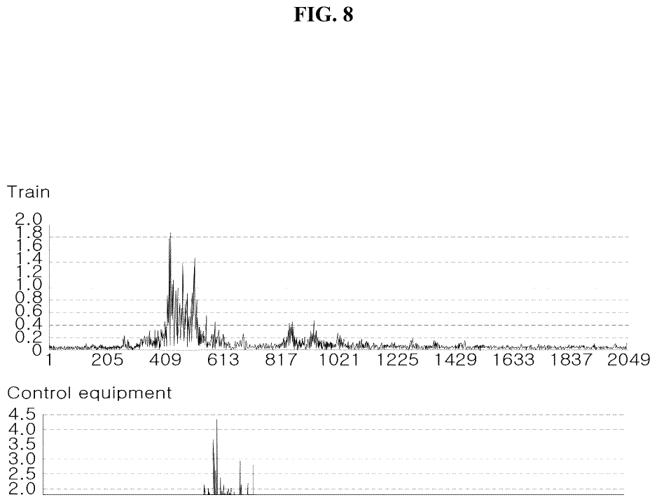

Hereinafter, a leakage determination apparatus using pipeline characteristics and a noise pattern and a learning method thereof according to an embodiment of the present disclosure will be described with reference to FIGS. 1 to 8.

At least one component may be added or deleted in response to the performance of the components illustrated in FIG. 1. Furthermore, it will be easily understood by those skilled in the art that mutual locations of the components may be changed in response to the performance or structure of the system.

Each component shown in FIG. 1 refers to software components and/or hardware components such as field programmable gate array (FPGA) and application specific integrated circuit (ASIC).

As illustrated in FIG. 1, a leakage determination apparatus using pipeline characteristics and noise patterns according to the present disclosure may include a first sensor unit 111 located at one end of a pipeline made of a first material, a second sensor unit 112 located at the other end of a pipeline made of a second material, a first detection unit 121 that detects a leakage location of the pipeline by using the first sensor unit 111 based on the pipeline made of the first material, a second detection unit 122 that detects a leakage location of the pipeline by using the second sensor unit 112 based on the pipeline made of the second material, a first leakage location correction unit 131 that applies a first correction value considering the characteristics of the first material to the leakage location detected by the first detection unit 121, and a second leakage location correction unit 132 applies a second correction value considering the characteristics of the second material to the leakage location detected by the second detection unit 122.

Moreover, the leakage location detection apparatus according to an embodiment of the present disclosure may further include a leakage location determination unit 140 that determines an average value of a first leakage location reflecting the first correction value, and a second leakage location reflecting the second correction value as a final leakage location.

In addition, the leakage determination apparatus using pipeline characteristics and a noise pattern according to an embodiment of the present disclosure may include a leakage determination unit 200 that determines whether a leakage is actually occurring at the determined final leakage location.

In detail, as illustrated in FIG. 2, the leakage determination unit 200 may include a signal collection unit 210 that collects vibration signals from the first sensor unit 111 and the second sensor unit 112 positioned in a pipeline.

The vibration signals collected from the signal collection unit 210 may include various signals, such as signals generated by pipeline characteristics, internal noise signals generated within the pipeline, external noise signals generated outside the pipeline, and leakage signals generated at a location where a leakage occurs.

Accordingly, a pipeline characteristic classification unit 220 of the leakage determination unit 200 may classify the vibration signal based on pre-stored pipeline characteristics. The pipeline characteristics may be at least one of a material, a diameter, and a thickness of the pipeline. In particular, when the pipeline is composed of a plurality of different materials, characteristics according to each material may be included.

Furthermore, before the pipeline characteristic classification unit 220 classifies the vibration signal according to pipeline characteristics, the collected vibration signal may be converted to a frequency signal and the converted frequency signal may be segmented into a plurality of sections.

For example, a vibration signal of a time domain may be frequency-converted into a frequency signal, and the converted frequency signal may be split into 100 Hz units for each frequency band. The signal may then be classified by pipeline characteristics such as a material, a diameter, and a thickness.

Differences may be detected in greater detail by comparing the divided units rather than the entire signal. In this case, as the number of units into which a frequency signal is split is smaller, the more frequency signals are generated, which increases a data volume. On the other hand, as the number of units is larger, the fewer frequency signals are generated, which does not significantly increase the data volume.

By segmenting the frequency signal to increase the data volume, more accurate and detailed values may be obtained while more training data may be obtained.

Accordingly, the converted frequency signal may be segmented by setting the unit size based on the converted frequency characteristics or the data volume in the obtained signal.

In other words, the leakage determination unit 200 may adjust the unit for segmenting the converted frequency signal based on the number of collected vibration signals.

A noise filtering unit 230 of the leakage determination unit 200 may compare the frequency signal classified according to the pipeline characteristics with the corresponding section of a preset leakage signal and may output and filter a noise frequency signal within the frequency signal.

The noise filtering unit 230 may compare a reference leakage signal with a frequency signal including noise by using the pattern of the preset leakage signal as the reference leakage signal to calculate a noise signal.

When the calculated noise frequency signal is in a noise band, the noise filtering unit 230 may filter the calculated noise frequency signal through using a bandpass filter in a frequency domain. Alternatively, when a difference between the reference leakage signal and the noise frequency signal is outside the noise band, noise may be minimized by calculating the difference in signal intensity.

A learning unit 240 of the leakage determination unit 200 may perform learning by using the processed signal to determine whether a leakage is present, based on the processed signal including a leakage signal corresponding to the reference leakage signal.

In an embodiment, the noise frequency signal may vary depending on a noise type.

The noise type may include internal noise generated within the pipeline and external noise generated outside the pipeline.

For example, the internal noise may include the sound of water being used or the bursting sound of water hitting a curved pipe, and the external noise may include at least one of the operating sound of a control device operating the pipeline, the operating sound of a transformer, the operating sound of a fan, and the sound of a train passing by. Besides, noises generated inside and outside the pipeline may be included.

Accordingly, the leakage determination unit 200 may determine a leakage by using an AI model, and may determine whether a leakage occurs in the pipeline, by input a signal obtained by performing time conversion on a frequency signal, from which the noise frequency signal is removed, into the learned AI model.

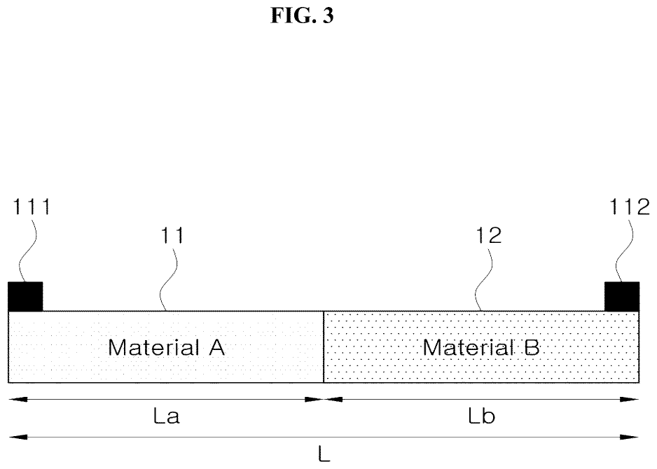

With regard to the pipeline characteristic classification unit 220, as shown in FIG. 3, it is assumed that a first material is a material ‘A’ 11; a second material is a material ‘B’ 12; a pipeline length of the material ‘A’ 11 is La; a pipeline length of the material ‘B’ 12 is Lb; and, the total pipeline length of the section where a leakage occurs is ‘L’.

The first sensor unit 111 may be installed at one end of the material ‘A’ 11, and the second sensor unit 112 may be installed at one end of the material ‘B’ 12. In this case, the one end of material ‘B’ 12 may be an end spaced apart from material ‘A’ 11.

According to an embodiment, the first sensor unit 111 or the second sensor unit 112 may be a vibration sensor. The leakage location may be detected by using information obtained by transmitting a vibration waveform to the leakage location.

For example, when a leakage location occurs in the material ‘A’ 11, the vibration waveform generated from the first sensor unit 111 passes through only the material ‘A’ 11 to reach the leakage location, and the vibration waveform generated from the second sensor unit 112 passes through both the material ‘B’ 12 and the material ‘A’ 11 to reach the leakage location.

For this reason, the signal passing through only the material ‘A’ 11 is affected only by the pipeline signal characteristic value of the material ‘A’ 11, and the signals passing through both the material ‘A’ 11 and the material ‘B’ 12 may be affected by both the pipeline signal characteristic value of the material ‘A’ 11 and the pipeline signal characteristic value of the material ‘B’ 12.

Accordingly, the leakage location may be accurately detected by reflecting a correction value considering the characteristics of each material to the measured value of the sensor unit in a pipeline composed of different materials.

Furthermore, the leakage determination unit 200 may calculate the leakage characteristic value for each pipeline material by multiplying the vibration transmission velocity in the first material or the second material by the pipe length of the first material or the second material among the total pipeline length.

The pipeline characteristic classification unit 220 of the leakage determination unit 200 may classify leakage characteristic values for the respective pipeline material and may remove pipeline material-specific characteristics from the leakage signal. The learning unit 240 may learn an AI model to output leakage judgments by learning leakage signals that do not include the pipeline material-specific characteristics.

The reference leakage value may be set by extracting it from a database storing existing leakage measurement results.

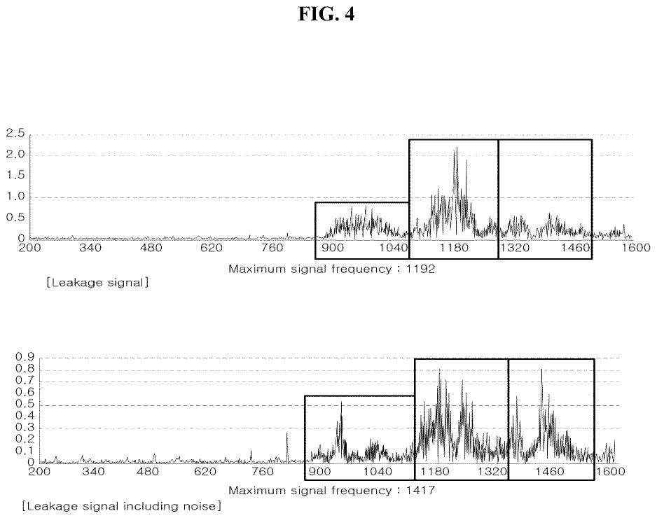

Regarding the noise filtering unit 230, noise filtering may be performed by comparing a leakage signal with a leakage signal including noise, as illustrated in FIG. 4. In the case, the leakage signal may be a reference leakage signal, and the leakage signal including noise may be a frequency signal obtained by converting a vibration signal collected by the signal collection unit 210.

Referring to FIG. 4, the noise filtering unit 230 may split a leakage signal and a leakage signal including noise into three sections in units of 100 Hz and may compare corresponding frequency bands. Noise filtering may be performed after it is recognized that the leakage signal including noise includes noise through the fact that the leakage signal has a maximum signal frequency of 1192 Hz and the leakage signal including noise has a maximum signal frequency of 1417 Hz.

When the remaining signal component obtained by filtering the leakage signal including noise matches a leakage occurrence signal stored in a database, the leakage determination unit 200 may determine that a leakage is occurring and may provide an alarm to a user.

Through the above-described process, all external factors other than the signal component generated by a leakage may be removed, thereby accurately determining the leakage.

Accordingly, according to an embodiment of the present disclosure, an apparatus for determining a leakage using pipeline characteristics and a noise pattern may include a memory, in which at least one process for determining a leakage using the pipeline characteristics and the noise pattern is stored, and a processor that performs an operation according to the process. According to an embodiment of the present disclosure, the processor of the apparatus for determining a leakage using pipeline characteristics and a noise pattern may be configured to preset a pattern of a leakage signal generated in the pipeline, to collect a vibration signal from a sensor unit installed in the pipeline, to remove a signal according to the pipeline characteristics from a collected vibration signal, to compare a removed vibration signal with a preset noise pattern so as to remove a corresponding noise pattern, and to generate a vibration signal, from which the noise pattern is removed, as learning data so as to determine whether a leakage occurs, through a comparison with the set pattern of the leakage signal.

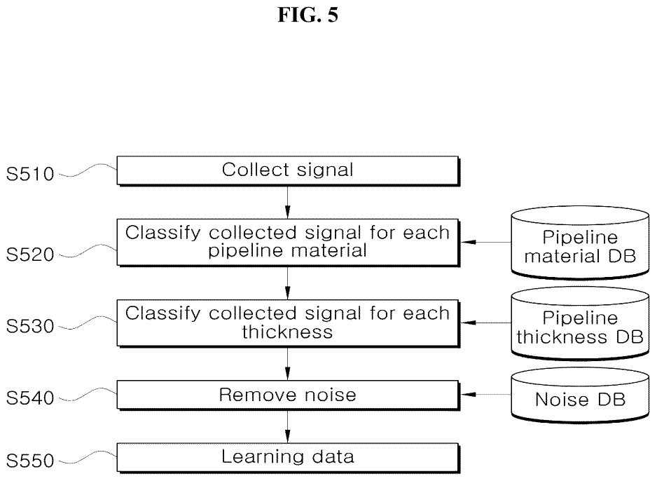

As shown in FIG. 5, signals may be collected from the first sensor unit 111 or the second sensor unit 112 installed in the pipeline (S510), and the collected signals may be classified for each pipeline material (S520). In this case, the signal characteristics for each pipeline material may be obtained from a pipeline material database.

Moreover, the signals classified for each pipeline material may be classified for each pipeline thickness (S530). In the case, pipeline thickness signal characteristics may be obtained from a pipeline thickness database.

In addition, noise removal may be performed on signals that do not exhibit differences based on pipeline material or thickness after being classified for each pipeline material and for each pipeline thickness (S540). Noise may be removed in consideration of noise patterns stored in a noise database.

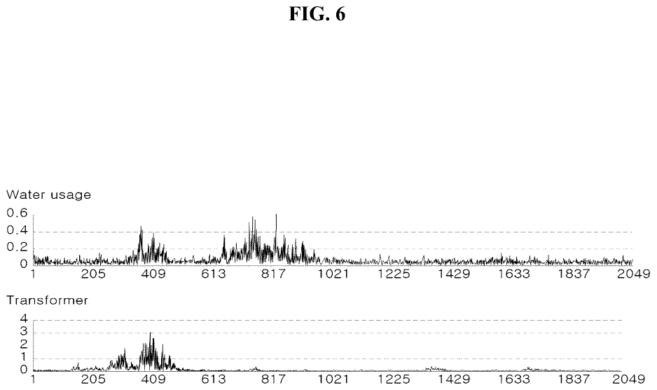

For example, FIGS. 6 to 8 illustrate noise of water being used generated when water collides with a pipeline as residents use a water supply system, noise of a transformer resonating from the pipeline as the transformer operates, noise of a curved pipe generated when water impacts the curved pipe, noise of a fan generated when the fan operates, noise of a train transmitted to a pipeline as the nearby train passes, and noise of control equipment generated when the control equipment operates. The pieces of noise of frequency signals may be stored in a database (DB) and then may be stored in a noise DB.

Noise may be removed from signals classified depending on a pipeline material and a pipeline thickness based on the corresponding noise pattern in consideration of signal intensity or a frequency band where the maximum signal frequency occurs. Removal efficiency may be improved by classifying and removing noise for each type.

In addition to detecting and removing noise corresponding to the aforementioned noise patterns, signals in a frequency band of 400 Hz or lower and signals in a frequency band of 1400 Hz or higher may also be removed.

Then, characteristics of each material and each thickness may be subtracted from the collected signal, and the noise-removed signal may be generated as learning data (S550).

As an embodiment, the leakage determination unit 200 may perform bandpass filtering on a frequency band including the noise frequency signal to remove the noise frequency signal from the frequency signal, or may perform amplification based on a difference in signal intensity between the frequency band including the noise frequency signal and a frequency band not including the noise frequency signal.

In the meantime, according to an embodiment of the present disclosure, a learning method of a leakage determination using pipeline characteristics and a noise patterns includes presetting a pattern of a leakage signal generated in a pipeline, collecting a vibration signal from a sensor unit installed in the pipeline, removing a signal according to the pipeline characteristics from a collected vibration signal, comparing a removed vibration signal with a preset noise pattern so as to remove a corresponding noise pattern, and generating a vibration signal, from which the noise pattern is removed, as learning data so as to determine whether a leakage occurs, through a comparison with the set pattern of the leakage signal. For the sake of brevity in the specification, any content the same as the description will be omitted.

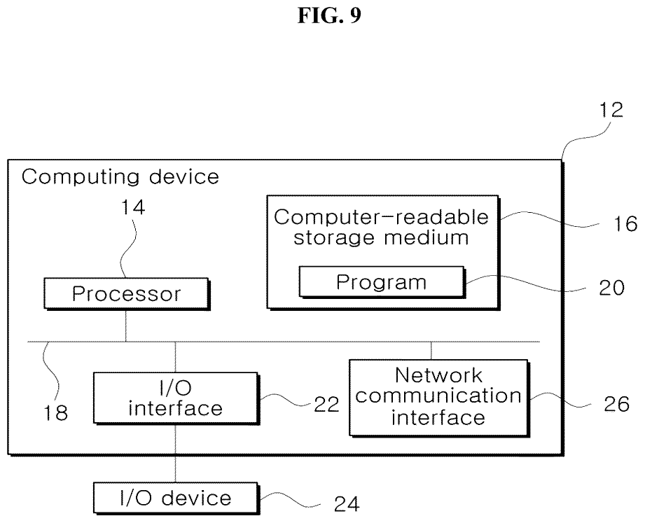

FIG. 9 illustrates a computing device, according to an embodiment of the present disclosure. As shown in FIG. 9, the leakage determination unit 200 according to an embodiment of the present disclosure may be implemented in a form of a recording medium storing computer-executable instructions. The instructions may be stored in a form of program codes, and, when executed by a processor, generate a program module to perform operations of the disclosed embodiments. The recording medium may be implemented as a computer-readable recording medium.

The leakage determination apparatus according to an embodiment of the present disclosure may correspond to a computing device 12, and the computing device 12 may include at least one processor 14, a computer-readable storage medium 16 including a program 20, and a communication bus 18.

Moreover, the computing device 12 may include one or more input/output (I/O) interfaces 22 that provide interfaces for I/O devices 24, and one or more network communication interfaces 26.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

According to the above-mentioned problem solving means of the present disclosure, when a leakage location is detected by using a plurality of sensor units in a pipeline of different materials, signals may be classified depending on the material properties and noise type of a pipeline to use only the signal generated by a leakage, thereby accurately detecting a leakage location.

Effects of the present disclosure are not limited to the effects mentioned above, and other effects not mentioned will be apparent by those skilled in the art from the following description.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

1. An apparatus for determining a leakage using pipeline characteristics and a noise pattern, the apparatus comprising:
a memory in which at least one process for determining the leakage using the pipeline characteristics and the noise pattern is stored; and
a processor configured to perform an operation according to the process,
wherein the processor is configured to:
preset a pattern of a leakage signal generated in a pipeline;
collect a vibration signal from a sensor unit installed in the pipeline;
remove a signal according to the pipeline characteristics from the collected vibration signal;
compare the removed vibration signal with a preset noise pattern so as to remove a corresponding noise pattern; and
generate a vibration signal, from which the noise pattern is removed, as learning data so as to determine whether the leakage occurs, through a comparison with the set pattern of the leakage signal.

2. The apparatus of claim 1, wherein the processor is further configured to:
convert the collected vibration signal into a frequency signal; and
segment the converted frequency signal into a preset unit.

3. The apparatus of claim 2, wherein the processor is configured to:
classify the segmented frequency signal according to the pipeline characteristics, and
wherein the pipeline characteristics include at least one of at least one material, at least one diameter, and at least one thickness of the pipeline.

4. The apparatus of claim 3, wherein the processor is configured to:
compare the frequency signal classified according to the pipeline characteristics with a corresponding section of the preset leakage signal and output a noise frequency signal within the frequency signal.

5. The apparatus of claim 4, wherein the processor is configured to:
input a signal obtained by performing time-conversion on a frequency signal, from which the noise frequency signal is removed, into an artificial intelligence (AI) model and determine whether the leakage occurs within the pipeline.

6. The apparatus of claim 5, wherein the noise frequency signal varies depending on a noise type.

7. The apparatus of claim 6, wherein the noise type includes internal noise that occurs inside the pipeline and external noise that occurs outside the pipeline.

8. The apparatus of claim 5, wherein the internal noise includes a sound of water being used or a bursting sound of water hitting a curved pipe, and
wherein the external noise includes at least one of an operating sound of a control device operating the pipeline, an operating sound of a transformer, an operating sound of a fan, and a sound of a train passing by.

9. The apparatus of claim 2, wherein the processor is configured to:
adjust the unit for segmenting the converted frequency signal according to a number of the collected vibration signal.

10. A method, which is performed by a processor of an apparatus and which is used to generate learning data for leakage determination using pipeline characteristics and a noise patterns, the method comprising:
presetting a pattern of a leakage signal generated in a pipeline;
collecting a vibration signal from a sensor unit installed in the pipeline;
removing a signal according to the pipeline characteristics from the collected vibration signal;
comparing the removed vibration signal with a preset noise pattern so as to remove a corresponding noise pattern; and
generating a vibration signal, from which the noise pattern is removed, as learning data so as to determine whether the leakage occurs, through a comparison with the set pattern of the leakage signal.
